(19) United States
(12) Patent Application Publication
(10) Pub. No.: US 2002/0157011 A1
(43) Pub. Date: Oct. 24, 2002

(54) Method and apparatus for secure transmission of identifier for removable storage media

(76) Inventor: Fred C. Thomas III, Ogden, UT (US)

Correspondence Address: Jerry W. Mills, Esq., Baker Botts L.L.P., Suite 600, 2001 Ross Avenue, Dallas, TX, 75201-2980, US

(21) Appl. No.: 09/839,515

(22) Filed: Apr. 20, 2001

(51) Int. Cl. G06F 12/14

(52) U.S. Cl. 713/193

(57) ABSTRACT

A media serial number (MS#) for a removable data storage cartridge (22) is asymmetrically encrypted using a private key (106) from a key list (103) which never leaves the factory. This factory encrypted value (FEMS#) is stored in a secure memory device (46) in the cartridge, along with an identifier (FKI#). A drive (21) can obtain the encrypted value and associated identifier from the memory device, and pass them to a requesting program (76), which has a list (176) that it accesses with the identifier to obtain a public key it then uses to decrypt the information. An additional feature involves a second level of asymmetric encryption using additional lists of public and private keys. Another feature permits the requesting program to include in its request a random number, which is subsequently included with the information encrypted at the second level.

### TECHNICAL FIELD OF THE INVENTION

The present invention relates in general to data storage devices that have a removable data storage cartridge and, more particularly, to a method and apparatus for linking a block of information to a particular removable cartridge in which it is stored.

### BACKGROUND OF THE INVENTION

Computer technology has evolved very rapidly over the past twenty-five years. Further, as one aspect of this, use of the Internet has grown extremely rapidly over the past five years. In association with the growth in these areas, progressively increasing amounts of information are becoming available in digital form. Also computer technology has made it very easy to create copies of information that is in digital form.

There are certain types of information as to which it is desirable to have the capability to distribute the information in digital form, but as to which there may be restrictions on copying of the information, for example where the information is protected by copyright laws. One example is music in digital form, such as a digital version of a song performed by a popular artist. An application program handling a block of information that represents music in digital form may wish to store this information on the storage media located in a removable data storage cartridge. However, in order to avoid unauthorized copying of this information, the application program may wish to tie this information to the specific physical cartridge in which the information is stored. If someone then copied that information to a different cartridge in an unauthorized manner, the application program could detect this and treat the unauthorized copy as invalid. Considerations of this type are commonly referred to as Digital Rights Management (DRM) issues.

As a practical matter, communications between the application program and the removable cartridge will usually need to pass through one or more intermediate software routines. As is well known, there are many computer experts, commonly referred to as “hackers”, who enjoy the challenge of trying to break or “hack” any form of computer-related security scheme, especially security schemes that seek to prevent unauthorized copying of digital information. In the situation of interest here, a hacker would typically attempt to gain undetected access to the channel of communication between the application program and the removable cartridge currently installed in the system. For example, the hacker might attempt to modify the program code of one of the existing routines through which this communication channel extends. Alternatively, the hacker might attempt to insert between two of the existing programs along the communication channel an undetectable additional program known as a shim.

If a hacker is able to gain undetected access to the channel of communication between the application program and the removable cartridge, the hacker can alter information passing between the application program and the cartridge in a manner which will fool the application program into believing that the removable cartridge currently installed in the system is really a different removable cartridge. This in turn gives the hacker the capability to thwart any attempt by the application program to tie a particular block of information to one particular cartridge. This is because, when the application program reads that block of information from a cartridge, it will never know with certainty whether the cartridge it is reading the information from is the cartridge that the information is supposed to be on, or some other cartridge.

Thus, the application program could be made to treat both the original copy on one cartridge and unauthorized copies on other cartridges as valid, which in turn means that the hacker could make a large number of unauthorized copies and pass them off as valid copies. Accordingly, in order to give an application program the capability to tie a block of information to a particular cartridge on which it is stored, a technique is needed for passing at least some information between the application program and cartridge in a manner so that it is difficult or impossible for a hacker to alter that information without detection.

### SUMMARY OF THE INVENTION

From the foregoing, it may be appreciated that a need has arisen for a method and apparatus for permitting a block of digital information to be tied to a particular physical storage media on which the information is stored. According to the present invention, a method and apparatus are provided to address this need, and involve: associating a unique identifier with a cartridge having an information storage media therein; providing a receiving section into which the cartridge can be removably inserted, the receiving section being operatively coupled to a further section; responding to the occurrence of a predetermined event when the cartridge is removably inserted in the receiving section by causing the receiving section to transmit to the further section public key information and an encrypted segment, where the encrypted segment has been formed through asymmetric encryption with a private key of a data segment which includes the unique identifier; and decrypting the encrypted segment in the further section as a function of the public key information, in order to obtain access to the unique identifier.

### BRIEF DESCRIPTION OF THE DRAWINGS

A better understanding of the present invention will be realized from the detailed description which follows, taken in conjunction with the accompanying drawings, in which:

FIG. 1 is a diagrammatic view of a system 10 which embodies the present invention, and which includes a host computer coupled by a cable to a drive that can receive a removable data storage cartridge;

FIG. 2 is a block diagram of the system of FIG. 1, showing selected components disposed within the host computer, the drive and the cartridge;

FIG. 3 is a block diagram showing how certain information flows within the system of FIG. 1, in a manner encompassed by the present invention; and

FIGS. 4-6 are respective flowcharts that each show a sequence of operations which is carried out by a respective different software routine within the system of FIG. 1, and which embodies aspects of the present invention.

### DETAILED DESCRIPTION OF THE INVENTION

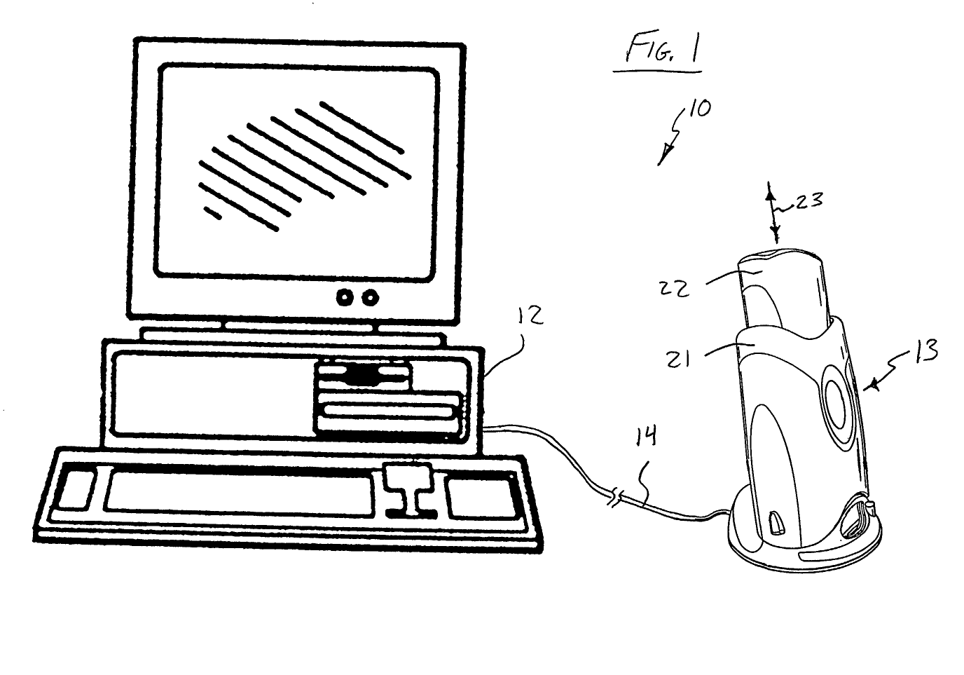

FIG. 1 is a diagrammatic view of a system 10 which includes a host computer 12 and a data storage device 13, the computer 12 and storage device 13 being operatively coupled by a cable 14. The hardware of the computer 12 is a commercially available product of the type commonly known as a personal computer. Suitable products of this type are available from Dell Computer Corporation of Austin, Tex. Communications through the cable 14 are effected according to an industry standard protocol, for example the industry standard Universal Serial Bus (USB) protocol, the industry standard Small Computer System Interface (SCSI) protocol, the industry standard IEEE 1394 protocol promulgated by the Institute of Electrical and Electronic Engineers (IEEE), or some other suitable existing or future protocol.

The data storage device 13 includes a cradle or drive 21 with an upwardly open recess, and a data storage cartridge 22 which is removably inserted into the recess in the drive 21. The cartridge 22 is inserted into and removed from the drive 21 in approximately vertical directions, as indicated diagrammatically in FIG. 1 by a double-headed arrow 23.

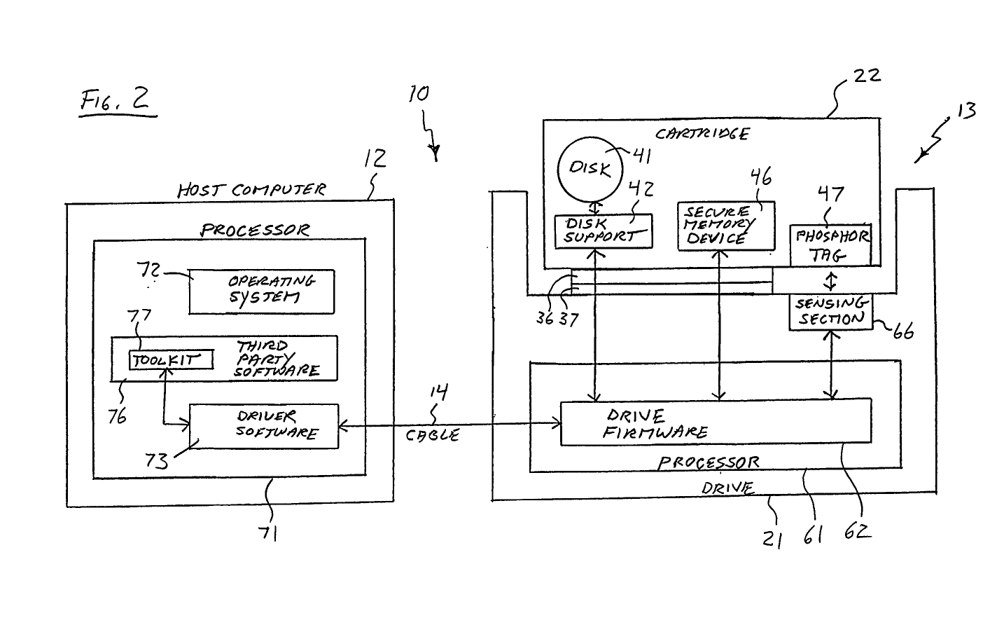

FIG. 2 is a high-level block diagram of the system 10 of FIG. 1, showing selected internal components of the host computer 12 and the data storage device 13. FIG. 2 is not intended to show all internal components of the computer 12 or the device 13, but instead depicts a subset of their internal components which will facilitate an understanding of the present invention. In this regard, the cartridge 22 has a connector 36, and the drive 21 has a connector 37, and the connectors 36 and 37 are releasably engaged when the cartridge 22 has been properly inserted into the drive 21, as shown diagrammatically in FIG. 2. The connectors 36-37 electrically couple circuitry within the cartridge 22 to circuitry within the drive 21.

The cartridge 22 includes a rotatably supported magnetic hard disk 41 of a known type. The disk 41 serves as a media within the cartridge 22 on which digital information can be stored. A disk support section 42 includes structure and circuitry of a type known in the art, which facilitates transfer of data to and from the disk 41. For example, the disk support section 42 includes a not-illustrated spin motor which effects rotation of the disk, a not-illustrated arm which is pivotally supported and which supports a read/write head for movement adjacent a magnetic surface of the disk 41, and a not-illustrated voice coil motor (VCM) which controls pivotal movement of the arm. Further, the disk support section 42 includes a not-illustrated preamplifier which processes electrical signals traveling between the drive 21 and the disk 41. The configuration and operation of the disk support section 42 represents technology which is known in the art, and the internal structure of the disk support section 42 is therefore not illustrated and described here in detail.

The cartridge 22 also includes a secure memory device (SMD) 46, which in the enclosed embodiment is commercially available as part number AT88SC153 from Atmel Corporation of San Jose, Calif. The SMD 46 is capable of storing a limited amount of information with a level of security that prevents an external device from accessing the stored information unless the external device successfully carries out interaction with the SMD according to an authentication procedure. The cartridge 22 also has a phosphor tag 47 on an external surface thereof, for a purpose discussed later.

The drive 21 includes a microprocessor 61 of a known type, which executes a drive firmware program indicated diagrammatically at 62. The drive firmware 62 can interact with the SMD 46, and can transfer data to and from the disk 41 through the disk support section 42. The drive 21 also includes a sensing section 66 which, when the cartridge 22 is present in the drive 21, is adjacent and aligned with the phosphor tag 47 provided on the cartridge. The sensing section 66 is controlled by the drive firmware 62.

Under control of the drive firmware 62, the sensing section 66 can briefly illuminate the phosphor tag 47 with a red light emitting diode (LED), which is not separately illustrated, and which causes the phosphor tag 47 to absorb radiation. The LED is then turned off, and the phosphor tag 47 emits radiation which it has absorbed. A not-illustrated sensor in the sensing section 66 can measure one or more characteristics of the emitted radiation, such as its amplitude and decay rate, or some other characteristic. Different characteristics identify different types of cartridges.

For example, different versions of the cartridge 22 may have disks 41 with differing amounts of storage capacity. It is possible for the drive 21 to determine which of these versions of the cartridge is currently inserted, based on the characteristics of the radiation emitted by the phosphor tag 47 on that cartridge. This provides the drive 21 with some knowledge about what is located inside the cartridge 22, which helps the drive 21 interact with the cartridge 22. Further, the drive 21 can use the information obtained from the phosphor tag 47 to distinguish between cartridges with which it is compatible, and cartridges with which it is not compatible. The configuration and operation of the sensing section 66 represents technology which is known in the art, and the sensing section 66 is therefore not illustrated and described here in further detail.

The host computer 12 includes a microprocessor 71 of a known type, which executes an operating system 72. The operating system 72 may be any suitable operating system that is available commercially available, such as one of the operating systems sold under the tradename WINDOWS by Microsoft Corporation of Redmond, Wash. The processor 71 also executes driver software 73, which includes routines developed by the manufacturer of the data storage device 13 in order to provide an interface between the data storage device 13 and application programs running within the processor 71. One such application program is indicated at 76, and is also referred to here as third-party software in order to emphasize that, except for a small portion thereof referred to as a toolkit 77, the application program 76 originates from a person or entity other than the entity which manufactures the data storage device 13 and the associated driver software 73. The toolkit 77 includes a series of software routines that can be called by the application program 76, and that each know how to find and communicate with the driver software 73. The toolkit originates from the manufacturer of the data storage device 13 and driver software 73, in order to provide various application programs with a simple and standard tool that they can use to accurately and reliably communicate with the driver software 73.

There are certain types of information which it is desirable to have in digital form, but as to which it is also desirable to prevent unauthorized copying. One example is music in digital form, such as a song by a popular artist. It is desirable that the capability exist to sell and deliver a copy of this music in digital form, for example through the Internet, but there is also a desire that a technique be provided to prevent the purchaser from making unauthorized copies of the purchased copy. Issues of this type are commonly referred to as Digital Rights Management (DRM) issues.

In the disclosed embodiment, the application program 76 handles digital information of this general type, as to which unauthorized copying is to be prevented. The application program 76 has the capability to tie a particular block of digital information to the particular cartridge 22 containing the disk 41 on which the information is stored. Once the application program 76 has stored the block of information in a particular cartridge 22, the application program will treat that block of information as valid only so long as it is read from that same cartridge 22. If that block of information is copied to a second cartridge, and if the second cartridge is then inserted into the drive 21, the application program 76 will refuse to recognize the block of information, because it is on a cartridge different than the cartridge in which the application program stored that block of information.

In order to implement this approach to digital rights management, the present invention provides the application program 76 with the capability to reliably and uniquely identify each cartridge 22. More specifically, each cartridge 22 is given a unique identifier in the form of a unique serial number. Further, the invention provides a technique that permits the application program 76 to obtain that unique serial number from the cartridge 22 in an authenticated and unaltered form.

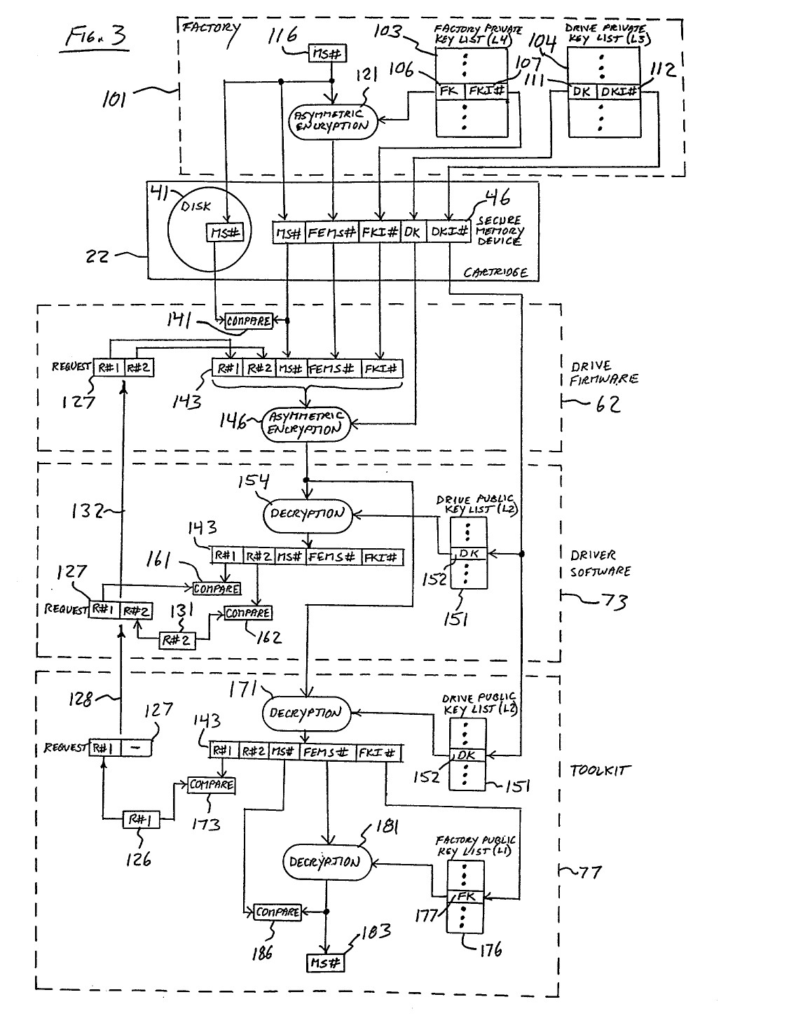

This is because, as is well known, there are many computer experts who enjoy the challenge of trying to defeat security schemes, particularly those schemes which are intended to prevent unauthorized copying. These persons are often referred to as “hackers”. The application program 76 can be written to protect itself from hackers, but would typically not be in a good position to protect itself from attempts by a hacker to make undetectable alterations to communications traveling between the application program 76 and the cartridge 22. For example, a hacker might modify the software of an existing routine along the path of communications, such as the driver software 73, or might insert an additional program known as a shim between two existing programs along that path, such as the application program 76 and the driver software 73. Through some technique of this type, a hacker could attempt to replace an actual serial number from the cartridge 22 with a substitute serial number that is passed on to the application program 76, in an attempt to fool the application program 76 into thinking that the cartridge actually disposed in the drive 21 is a different cartridge. One feature of the present invention is that it provides an extremely high level of assurance that a serial number can be reliably delivered from a cartridge 22 to the application program 76 in an authenticated and unaltered form, so that the application program 76 has an extremely high level of confidence that it can accurately identify which particular cartridge 22 is currently present in the drive 21. This technique will now be explained in more detail, with reference to FIG. 3.

FIG. 3 is a block diagram showing a flow of information according to one form of the present invention. FIG. 3 includes a diagrammatic representation of the cartridge 22, including the disk 41 and the SMD 46 disposed therein. FIG. 3 also has broken lines which diagrammatically indicate the drive firmware 62, the driver software 73 and the toolkit 77. Further, a factory 101 which manufactures the cartridge 22 is indicated diagrammatically by broken lines.

As will become evident from the discussion which follows, the present invention uses data encryption to contribute to the security of certain data being transferred within the system 10. As is known in the art, encryption schemes are generally classified as either symmetric or asymmetric. In a symmetric encryption scheme, a single key is to encrypt the data and also to subsequently decrypt the data. In an asymmetric encryption scheme, one key is used to encrypt the data, but it cannot be used to thereafter decrypt that encrypted data. Instead, an entirely different key is needed to decrypt the encrypted data.

One of the two keys for asymmetric encryption is usually subject to a higher level of security than the other key. The key with the higher level of security is commonly referred to as a private key, and the other key is commonly referred to as a public key. Depending on the particular circumstances, the private key may be either the key which is used for encryption, or the key which is used for decryption.

Various different types of asymmetric encryption are known in the art, and the disclosed embodiment uses one of these known techniques. More specifically, the disclosed embodiment uses an existing technique which is commonly known as elliptic curve cryptography (ECC). However, other types of encryption could be used for the present invention, including not only techniques that are already known, but techniques that may be developed in the future.

Turning now in more detail to FIG. 3, the factory 101 maintains two lists 103 and 104, which each include a plurality of private keys. In the disclosed embodiment, each of these lists contains fifty keys, but each list could alternatively contain a larger or smaller number of keys.

The list 103 is a factory private key list (L4), which has fifty entries or records that each include a respective different factory key (FK) 106, and a respective factory key index number (FKI#) 107. The list 103 is subject to strict security within the factory 101, and the keys in the list are used only within the factory 101. None of the keys 106 in the list 103 ever leave the factory 101.

The second list 104 is a drive private key list (L3), and each entry in this list includes a respective different drive key (DK) 111, and a respective drive key index number (DKI#) 112. The list 104 is also maintained under strict security within the factory. The drive keys DK 111 do leave the factory 101, but only one of the drive keys DK 111 leaves the factory 101 in any given cartridge 22, as discussed below.

When a cartridge 22 is being manufactured by the factory 101, one of the entries in table 103 is selected, and one of the entries in table 104 is selected. Further, a unique identifier is selected at 116. In the disclosed embodiment, the unique identifier 116 is a media serial number (MS#), but the present invention encompasses the use of some other form of unique identifier. The media serial number MS# is stored in three different forms within the cartridge 22. First, it is stored on the disk 41 in an unencrypted form. Second, it is stored within the SMD 46 in an identical unencrypted form. Third, the factory private key FK 106 from the selected entry of the list 103 is used at 121 to effect asymmetric encryption of a data segment which is the media serial number MS#, in order to obtain an encrypted data segment which is a factory encrypted media serial number (FEMS#). The factory encrypted media serial number (FEMS#) is then stored within the SMD 46. The factory key index number FKI# 107, the drive private key DK 111, and the drive key index number DKI# 112 from the selected entries in lists 103 and 104 are also each stored in the SMD 46 in an unencrypted form. The cartridge 22 is subsequently shipped from the factory for commercial sale and operational use.

With reference to FIG. 2, it is assumed for purposes of discussion that the cartridge 22 is installed in the system 10 at some point after it has been shipped by the factory 101, and that the application program 76 wishes to obtain the media serial number MS# for the cartridge 22 in an authenticated and unaltered form. Referring to FIGS. 2 and 3, this is carried out in the following manner.

The application program 76 places a call to one of the routines in the toolkit 77, which is represented diagrammatically in the lower portion of FIG. 3. This toolkit routine is designed to generate a request for an authenticated transfer (AT) of the media serial number MS# from the cartridge 22 back to the toolkit routine. This toolkit routine begins by generating a random number R#1 at 126, using techniques which are known in the art. This random number may be either a true random number, or a pseudo-random number, and serves as a form of security code, as discussed later. The toolkit routine saves the random number R#1 for subsequent use in a manner discussed later. The toolkit routine generates a request 127 for the authenticated transfer of the media serial number MS#. The request 127 includes the random number R#1. The toolkit routine transmits the request 127 to the driver software 73.

The driver software 73 responds to receipt of the request 127 by generating a second random number R#2, as indicated diagrammatically at 131. This random number is generated using known techniques, and may be either a true random number, or a pseudo-random number, and serves as a form of security code, as discussed later. The driver software 73 inserts this second random number R#2 into an available space within the request 127, and also saves both of the random numbers R#1 and R#2 for subsequent use, as discussed later. At 132, the driver software 73 then forwards the modified request 127 through the cable 14 to the drive firmware 62 within the drive 21.

With reference to FIG. 2, the drive firmware 62 responds to receipt of the request 127 by first using the sensing section 166 to illuminate the phosphor tag 47 on the cartridge, and to thereafter sense characteristics such as the amplitude and decay time of the radiation emitted by the tag 47. Using this sensed information, the drive firmware 62 verifies that the cartridge 22 which is present in the drive 21 is compatible with the drive 21.

Next, the drive firmware 62 takes the steps necessary to authenticate with the secure memory device SMD 46 in the cartridge 22, in order to obtain access to the data stored within the SMD. The drive firmware 62 then reads out this data which, as discussed above, includes the unencrypted media serial number MS#, the factory encrypted media serial number FEMS#, the factory key index number FKI#, the drive key DK, and the drive key index number DKI#. The drive firmware 62 also reads the media serial number MS# which is stored on the disk 41. Then, at 141, the drive firmware 62 compares the MS# obtained from the disk 41 with the MS# obtained from the SMD 46, in order to verify that they are the same. If they are different, then there is an error or problem, and the firmware 62 takes appropriate action, as discussed later.

Assuming that the numbers compared at 141 are found to be the same, the drive firmware 62 next prepares a data segment 143 which includes the two random numbers R#1 and R#2 received in the request 127, and which also includes the values obtained from the SMD 46 for the media serial number MS#, the factory encrypted media serial number FEMS#, and the factory key index number FKI#. Then, at 146, the drive firmware 62 uses the drive key DK obtained from the SMD 46 to effect asymmetric encryption of the data segment 143. Then, the drive firmware 62 passes this encrypted data segment through the cable 14 to the driver software 73, along with the drive key index number DKI# obtained from the SMD 46.

The driver software 73 includes a list (L2) which is indicated at 151. The list 151 has the same number of entries as the list 104 in the factory 101, which in the disclosed embodiment is fifty entries. Each entry in the list 151 contains a drive public key which is different from but corresponds to a respective one of the drive private keys in the list 104. That is, each drive public key in the list 151 can decrypt information that was encrypted by the corresponding private key in the factory list 104. In order to obtain the proper key from the list 151, the driver software 73 uses the drive key index number DKI# received from the drive firmware 62 as an index to the list 151, in order to identify an entry 152 which contains the drive public key that will properly decrypt the data segment which was encrypted at 146. The driver software 73 then uses this drive public key 152 from the list 151 in order to effect decryption at 154 of the encrypted data segment received from the drive firmware 62. The decryption at 154 yields in unencrypted form the data segment 143 that was prepared by the drive firmware 62 and then encrypted at 146.

At 161, the driver software 73 takes the random number R#1 which it previously saved, and compares it to the random number R#l from the data segment 143 it decrypted, in order to verify that they are equal. Similarly, at 162, the driver software 73 takes the random number R#2 which it previously saved, and compares it to the random number R#2 from the data segment 143 it decrypted, in order to verify that they are equal. If any discrepancy is detected in either comparison at 161 or 162, then there is a problem and the driver software 73 takes appropriate action, as discussed later. Assuming that no problem is detected, the driver software 73 will take the encrypted data segment and drive key index number DKI# that it received from the drive firmware 62, and pass these items in unaltered form to the routine in the toolkit 77.

This toolkit routine maintains the exact same key list 151 as the driver software 73. The toolkit routine uses the factory key index number FKI# as an index to the list 151, in the same manner that the driver software 73 used it as an index, in order to identify the drive public key 152 which will decrypt the data segment that was encrypted at 146. At 171, the toolkit routine uses the selected key 152 to decrypt this encrypted data segment, in order to obtain in unencrypted form the data segment 143 that was prepared by the drive firmware 62. The decryption carried out at 171 by the toolkit routine is equivalent to the decryption carried out at 154 by the driver software 73.

Next, at 173, the toolkit routine takes the random number R#1 which it previously stored, and compares it to the random number R#1 from the data segment 143 that it decrypted. If they are not equal, then there is a problem, and the toolkit routine takes appropriate action, as discussed later. Assuming that the numbers compared at 173 are found to be equal, the toolkit routine next effects decryption of the factory encrypted media serial number FEMS#.

In this regard, the toolkit routine maintains a list (L1) which is indicated at 176. The list 176 contains a plurality of factory public keys, each of which is different from but corresponds to a respective one of the keys in the factory private key list 103 maintained in the factory 101. The toolkit routine uses the factory key index number FKI# from the data segment 143 as an index to the list 176, in order to select a respective one of the keys from the list 176 which will properly decrypt the factory encrypted media serial number FEMS#. Then, at 181, the toolkit routine uses the selected key 177 from the list 176 to decrypt FEMS#, in order to thereby obtain from FEMS# the media serial number MS# indicated at 183.

The toolkit routine then takes the media serial number MS# obtained at 183 by decryption, and compares it at 186 with the media serial number MS# present in the data segment 143 which it decrypted at 171. If they are not equal, then there is a problem, and the toolkit routine can take appropriate action, as discussed later. But assuming that the numbers compared at 186 are found to be equal, then the media serial number MS# at 183 is an authenticated and unaltered serial number from the cartridge 22, and can be reliably used as a unique identifier for the cartridge 22 and the storage media therein, which is the disk 41. The toolkit routine 77 then passes this authenticated media serial number MS# 183 to the application program 76 (FIG. 2) in which the toolkit routine is embedded.

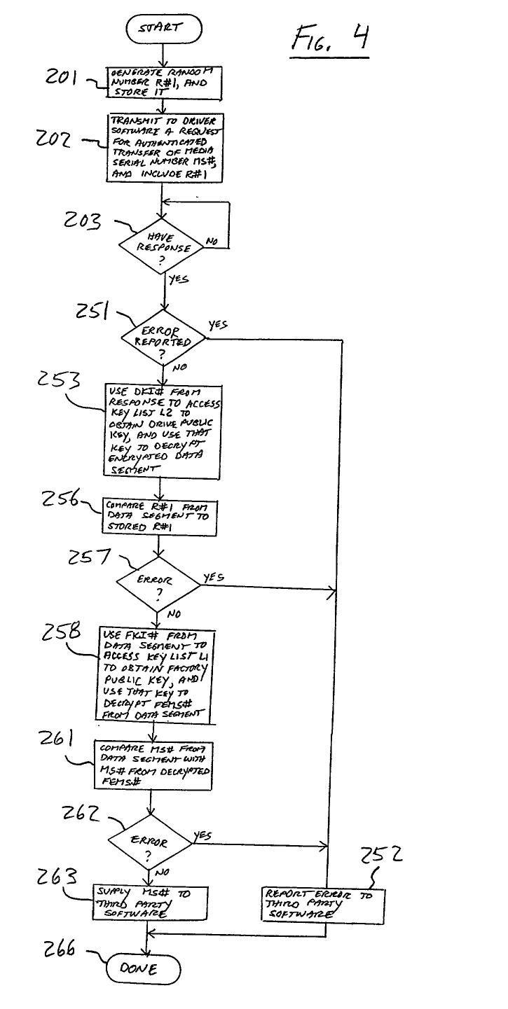

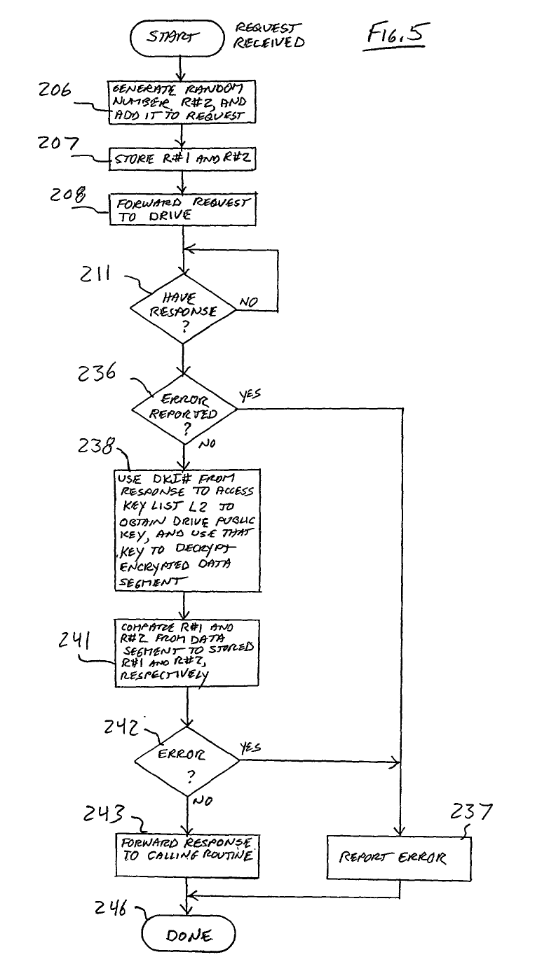

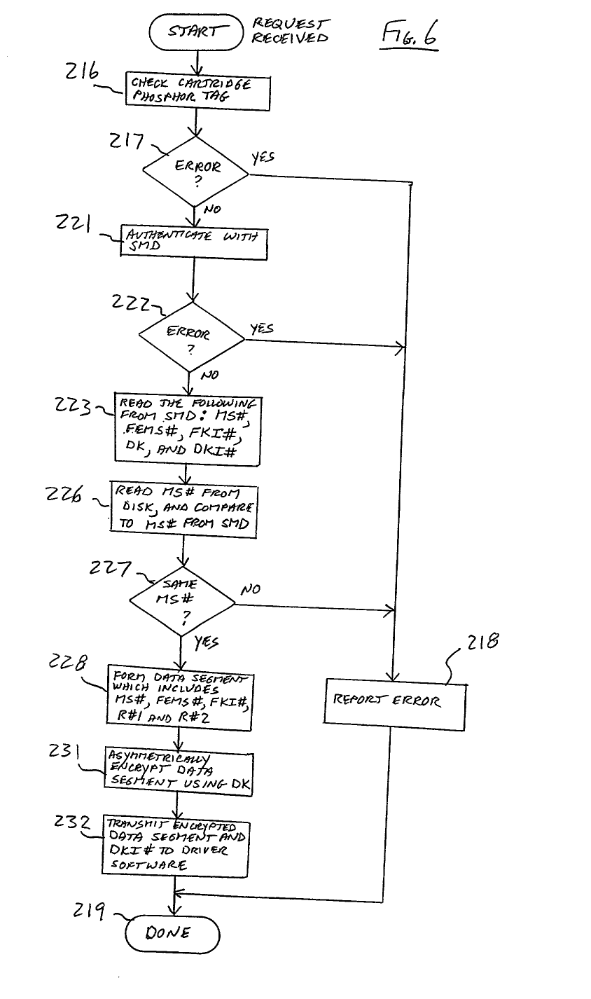

FIGS. 4-6 are flowcharts which collectively show in a different form the sequence of events that was discussed above with respect to FIG. 3. In this regard, FIG. 4 represents events which occur within the above-discussed routine in the toolkit 77, FIG. 5 represents events which occur within the driver software 73, and FIG. 6 represents events which occur within the drive firmware 62.

Beginning with FIG. 4, the illustrated routine begins when the application program 76 (FIG. 2) makes a call to the routine in the toolkit 77, in order to request an authenticated transfer from the cartridge 22 of its unique identifier, which is the media serial number MS#. At block 201, the toolkit routine generates the random number R#1, and stores it for later use. Then, at block 202, the toolkit routine formulates the request 127 (FIG. 3), and transmits it to the driver software 73, with the random number R#1 therein. Then, at block 203, the toolkit routine waits for a response. Block 203 would likely be an interrupt-driven routine, rather than an infinite loop, but for simplicity and clarity is shown conceptually in FIG. 4 as an infinite loop.

Turning to FIG. 5, execution of the indicated routine begins when the driver software 73 receives from the toolkit routine the request 127 generated at block 202 (FIG. 4). At block 206, the driver software 73 generates random number R#2, and inserts it into the request 127. Then, at block 207, the driver software 73 stores both of the random numbers R#1 and R#2 from the request 127. Next, at block 208, the driver software 73 transmits the modified request 127 to the firmware 62 in the drive 21. Then, at block 211, the driver software waits for a response. This wait would likely be implemented as an interrupt-driven routine, but for clarity it is shown conceptually in FIG. 5 as an infinite loop.

Turning to FIG. 6, execution of the illustrated routine begins in response to receipt by the drive firmware 62 of the request 127 that was forwarded at block 208 (FIG. 5). At block 216, the drive firmware 62 checks the cartridge's phosphor tag 47 (FIG. 2), in a manner already described above. Then, at 217, the drive firmware 62 evaluates whether there is any problem or error associated with the information that it obtained from the phosphor tag. If so, then control proceeds to block 218, where the drive firmware prepares a report which reflects the error, and which will be returned in lieu of data from the cartridge. The routine of FIG. 6 is then exited at block 219.

However, assuming that no problem or error was detected at block 217, control would proceed from block 217 to block 221, where the drive firmware 62 carries out authentication with the secure memory device SMD 46 (FIG. 2). Then, at block 222, the drive firmware 62 evaluates whether any problem or error was encountered in attempting to authenticate with the SMD 46. If so, then control proceeds to block 218 for purposes of reporting an error. Otherwise, control proceeds to block 223.

In block 223, the drive firmware 62 reads from the SMD 46 the pertinent elements of information which are stored therein, including the media serial number MS#, the factory encrypted media serial number FEMS#, the factory key index number FKI#, the drive key DK, and the drive key index number DKI#. Then, at block 226, the drive firmware 62 reads the media serial number MS# which is stored on the disk 41, and compares it to the MS# obtained from the SMD 46. This corresponds to the above-discussed comparison at 143 in FIG. 3. Then, at block 227, the drive firmware 62 checks to see whether the compared numbers are the same. If not, then there is a problem, and control proceeds to block 218 for purposes of reporting an error. Otherwise, control proceeds to block 228.

At block 228, the drive firmware 62 forms the data segment shown at 143 in FIG. 3, which includes MS#, FEMS#, FKI#, R#1 and R#2. Then, at block 231, the drive firmware 62 asymmetrically encrypts this data segment using the drive key DK obtained from the SMD 46. This encryption corresponds to block 146 in FIG. 3. Next, at block 232, the drive firmware 62 transmits to the driver software 73 the encrypted data segment, along with the drive key index number DKI# obtained from the SMD 46 in the cartridge. Control then proceeds to block 219, which represents the end of the routine of FIG. 6.

Referring again to FIG. 5, the driver software 73 will be waiting at block 211 for a response from the drive firmware 62. When a response is received, control proceeds to block 236, where the driver software 73 determines whether the response represents a report of an error. This would be the case if control had passed through block 218 in FIG. 6. If the drive firmware 62 has reported an error, then control proceeds from block 236 to block 237, where the driver software 73 prepares a report of the error to send back to the toolkit routine 77.

On the other hand, if it was determined at block 236 that the response from the drive firmware did not represent an error, control would proceed from block 236 to block 238. In block 238, the driver software 73 uses the drive key index number DKI# received from the drive firmware 62 as an index to its list 151 (FIG. 3), in order to obtain the appropriate drive public key 152, which it then uses to effect decryption of the encrypted data segment that it received from the drive firmware 62. This decryption corresponds to block 154 in FIG. 3.

Control then proceeds to block 241, where the driver software 73 compares each of the random numbers R#1 and R#2 that it previously stored with the respective corresponding random number R#1 or R#2 from the data segment it decrypted at block 238. These comparisons correspond to blocks 161 and 162 in FIG. 3. Then, at block 242, the driver software 73 checks to see whether the numbers used in each comparison were found to be equal. If not, then a problem or error has been detected, and control proceeds to block 237, in order to report an error back to the routine in toolkit 77.

Otherwise, control proceeds from block 242 to block 243, where the driver software 73 forwards to the toolkit routine in unaltered form the response which it received from the drive firmware 62. This response includes the encrypted data segment that was prepared in block 231 of FIG. 6, and also the drive key index number DKI#. Control then proceeds from block 243 to block 246, which represents the end of the routine of FIG. 5.

Referring back to FIG. 4, the routine in toolkit 77 will be waiting at block 203 for a response from the driver software 73. When a response is received, control proceeds from block 203 to block 251, where the toolkit routine checks to see if the response is a report of an error or problem. This would be the case if control had passed through block 218 in FIG. 6 and/or block 237 in FIG. 5. If the response is reporting an error, control proceeds from block 251 to block 252, where the toolkit routine reports the error back to the application program 76 (FIG. 2).

Otherwise, control proceeds from block 251 to block 253, where the toolkit routine uses the drive key index number DKI# that it received from the driver software 73 to access its key list 151, in order to obtain the appropriate drive public key needed to decrypt the encrypted data segment that it received from the driver software 73. It then uses the selected key 152 to effect this decryption, which corresponds to block 171 in FIG. 3.

Control then proceeds to block 256, where the toolkit routine compares the random number R#1 that it previously saved with the corresponding random number R#1 from the data segment that it decrypted at block 253. This comparison corresponds to block 173 in FIG. 3. Then, at block 257, the toolkit routine checks to see whether the numbers used in the comparison were found to be equal. If not, then a problem or error has been detected, and control proceeds to block 252, in order to report an error back to the application program 76.

Assuming that the numbers compared in block 256 were equal, control would proceed from block 257 to block 258, where the toolkit routine takes the factory key index number FKI# from the data segment it decrypted in block 253, and uses this index FKI# to access its drive public key list 176 (FIG. 3), in order to obtain the proper factory public key 177 needed to decrypt the factory encrypted media serial number FEMS#. The toolkit routine then uses that selected key 177 to effect decryption of FEMS#, which corresponds to block 181 in FIG. 3. Control then proceeds to block 261, where the toolkit routine compares the value of MS# obtained through decryption at block 258 with the value of MS# present in the data segment it decrypted at block 253. This corresponds to the comparison at 186 in FIG. 3. Then, at block 262, the toolkit routine checks to see whether the numbers it compared were equal. If not, then there is an error or problem, and control proceeds to block 252, for purposes of reporting this problem or error to the application program 76 (FIG. 2).

Otherwise, control proceeds from block 262 to block 263, where the toolkit routine supplies to the application program 76 the media serial number MS# which it obtained through decryption at block 258. This value of MS# represents an authenticated and unaltered value from the cartridge 22, which can be reliably used by the application program 76. The routine of FIG. 6 then ends at block 266.

The present invention provides a number of technical advantages. One such technical advantage is the capability to pass an authenticated and unaltered media serial number from a removable data storage cartridge to an application program through one or more intermediate routines, in response to an invoked authenticated transfer call by the application program. A related advantage is realized from the use of a level of asymmetric encryption, in which a private key list is maintained at a factory for the cartridges and never leaves the factory, and in which a selected one of the private keys from that list is used to prepare an encrypted version of the media serial number which is permanently stored in the cartridge. Because these private keys never leave the factory, and since only a selected one of these many keys is used in association with any given cartridge, it would be extremely difficult for someone to prepare a counterfeit version of the encrypted information, because they would need information that is never available in the public domain. Moreover, even if one key from the factory private list was somehow determined by a member of the public, it would be useless as to the majority of cartridges encountered by that person, because those other cartridges would contain information encrypted using other different keys from the list.

A further advantage results from the use of a further level of asymmetric encryption, in which the encryption is effected using a second private key list which is also maintained at the factory, where only one private key from this second list is placed in any given cartridge. Moreover, to the extent that one such key from the second list is placed in any given cartridge, it is advantageous that the key is stored in a secure memory device which can be accessed only after proper authentication. Still another advantage results from the fact that one or more software routines each have the capability to include, in a request for authenticated information, a respective random number, and the fact that each such random number is subsequently included in an encrypted response to the request.

Although one embodiment has been illustrated and described in detail, it will be understood that various substitutions and alterations are possible without departing from the spirit and scope of the present invention, as defined by the following claims.

What is claimed is:

1. An apparatus, comprising:
a cartridge having an information storage media therein, and having a unique identifier associated therewith;
a receiving section into which said cartridge can be removably inserted; and
a further section operatively coupled to said receiving section;
said receiving section being responsive to an occurrence of a predetermined event when said cartridge is removably inserted therein for transmitting to said further section public key information and an encrypted segment, where said encrypted segment has been formed through asymmetric encryption with a private key of a data segment which includes said unique identifier; and
said further section decrypting said encrypted segment as a function of said public key information, in order to obtain access to said unique identifier.

2. An apparatus according to claim 1,
wherein said further section includes a public key list containing a plurality of public keys;
wherein said public key information identifies one of said public keys in said list; and
wherein said further section uses said one public key to effect said decryption of said encrypted segment.

3. An apparatus according to claim 1,
wherein said private key, said public key information and said unique identifier are stored in said cartridge during manufacture thereof; and
wherein said receiving section reads said private key, said public key information and said unique identifier from said cartridge, and effects said asymmetric encryption of said unique identifier using said private key.

4. An apparatus according to claim 3,
wherein said cartridge includes a secure memory device;
wherein said private key, said public key information and said unique identifier are stored in said secure memory device; and
wherein said receiving section is operable to authenticate with said secure memory device in order to obtain access to the information stored therein.

5. An apparatus according to claim 4,
wherein said unique identifier is also stored on said storage media during manufacture of said cartridge; and
wherein said receiving section compares said unique identifier stored on said storage media to said unique identifier stored in said secure memory device.

6. An apparatus according to claim 3, wherein a private key list is maintained in a secure manner at a facility associated with cartridge manufacture, said private key list including a plurality of private keys and corresponding public key identifiers, said private key used for asymmetric encryption being one of said private keys selected from said private key list, and said public key information being the public key identifier corresponding to said selected private key.

7. An apparatus according to claim 6,
wherein said further section includes a public key list containing a plurality of public keys;
wherein said public key information identifies one of said public keys in said public key list; and
wherein said further section uses said one public key to effect said decryption of said encrypted segment.

8. An apparatus according to claim 3, wherein said further section is operable to transmit to said receiving section a request for said unique identifier, receipt of said request being said predetermined event.

9. An apparatus according to claim 8,
wherein said further section places in said request a security code; and
wherein said receiving section includes said security code in said data segment in said encrypted segment transmitted to said further section in response to said request, said further section effecting a comparison of said security code sent in said request to said security code received in said data segment.

10. An apparatus according to claim 9, including an additional section through which said further section and said receiving section communicate with each other, said additional section adding to said request a further security code, said receiving section including said further security code in said data segment in said encrypted segment, said additional section decrypting said encrypted segment as a function of said public key information, and said additional section effecting a comparison of said further security code sent in said request to said further security code received in said data segment.

11. An apparatus according to claim 10,
wherein said further section and said additional section each include a public key list containing a plurality of public keys;
wherein said public key information identifies one of said public keys in said list; and
wherein said further section and said additional section each use said one public key to effect said decryption of said encrypted segment.

12. An apparatus according to claim 10, wherein said comparison effected by said additional section includes comparison of each of said security codes from said request to a respective one of said security codes in said data segment.

13. An apparatus according to claim 10,
wherein said security code included in said request by said further section is a substantially random number selected dynamically by said further section; and
wherein said further security code added to said request by said additional section is a substantially random number selected dynamically by said additional section.

14. An apparatus according to claim 1,
wherein said encrypted segment and said public key information are stored in said cartridge during manufacture thereof; and
wherein said cartridge is free of said private key.

15. An apparatus according to claim 14,
wherein said cartridge includes a secure memory device;
wherein said public key information and said encrypted segment are stored in said secure memory device; and
wherein said receiving section is operable to authenticate with said secure memory device in order to obtain access to the information stored therein.

16. An apparatus according to claim 14, wherein a private key list is maintained in a secure manner at a facility associated with cartridge manufacture, said private key list including a plurality of private keys and corresponding public key identifiers, said private key used for asymmetric encryption being a selected one of said private keys from said private key list and said public key information being the public key identifier corresponding to said selected private key.

17. An apparatus according to claim 16,
wherein said further section includes a public key list containing a plurality of public keys;
wherein said public key information identifies one of said public keys in said list; and
wherein said further section uses said one public key to effect said decryption of said encrypted segment.

18. An apparatus according to claim 14,
wherein said unique identifier, a further private key, and further public key information are stored in said cartridge during manufacture thereof;
wherein said receiving section reads said further private key, said further public key information and said unique identifier from said cartridge;
wherein said receiving section forms a further data segment which includes said encrypted segment, said public key information associated with said encrypted segment, and said unique identifier;
wherein in response to said predetermined event said receiving section effects asymmetric encryption of said further data segment using said further private key to obtain a further encrypted segment;
wherein said receiving section transmits said further encrypted segment and said further public key information to said further section; and
wherein said further section decrypts said further encrypted segment as a function of said further public key information.

19. An apparatus according to claim 18, wherein said receiving section compares said unique identifier from said further data segment with said unique identifier obtained by decrypting said encrypted segment in said further data segment.

20. An apparatus according to claim 18,
wherein said cartridge includes a secure memory device;
wherein said encrypted segment, said public key information associated with said encrypted segment, said unique identifier, said further private key, and said further public key information are stored in said secure memory device; and
wherein said receiving section is operable to authenticate with said secure memory device in order to obtain access to the information stored therein.

21. An apparatus according to claim 18,
wherein first and second private key lists are maintained in a secure manner at a facility associated with cartridge manufacture;
wherein said first private key list includes a plurality of first private keys and corresponding first public key identifiers;
wherein a selected one of said first private keys from said first private key list is said private key used for asymmetric encryption of said encrypted segment stored in said cartridge, and said corresponding public key information is the first public key identifier corresponding to said selected first private key; and
wherein said second private key list includes a plurality of second private keys and corresponding second public key identifiers, said private key used for asymmetric encryption of said further encrypted segment being a selected one of said second private keys from said second private key list and said further public key information being the second public key identifier corresponding to said selected second private key.

22. An apparatus according to claim 21,
wherein said further section includes first and second public key lists which respectively contain a plurality of first and second public keys;
wherein said public key information associated with said encrypted segment stored in said cartridge identifies one of said public keys in said first public key list;
wherein said further public key information identifies one of said public keys in said second public key list; and
wherein said further section uses said one of said second public keys to decrypt said further encrypted segment and thereafter uses said one of said first public keys to decrypt said encrypted segment from said further data segment.

23. An apparatus according to claim 18, wherein said further section is operable to transmit to said receiving section a request for said unique identifier, receipt of said request being said predetermined event.

24. An apparatus according to claim 23,
wherein said further section places in said request a security code; and
wherein said receiving section includes said security code in said further data segment in said further encrypted segment transmitted to said further section in response to said request, said further section effecting a comparison of said security code sent in said request to said security code received in said further data segment.

25. An apparatus according to claim 24, including an additional section through which said further section and said receiving section communicate with each other, said additional section adding to said request a further security code, said receiving section including said further security code in said further data segment in said further encrypted segment, said additional section decrypting said further encrypted segment as a function of said further public key information, and said additional section effecting a comparison of said further security code sent in said request to said further security code received in said further data segment.

26. An apparatus according to claim 25,
wherein said further section includes first and second public key lists which respectively contain a plurality of first and second public keys;
wherein said additional section includes said second public key list;
wherein said public key information associated with said encrypted segment stored in said cartridge identifies one of said public keys in said first public key list;
wherein said further public key information identifies one of said public keys in said second public key list;
wherein said further section and said additional section each use said one of said second public keys to decrypt said further encrypted segment; and
wherein said further section uses said one of said first public keys to decrypt said encrypted segment from said further data segment.

27. An apparatus according to claim 25, wherein said comparison effected by said additional section includes comparison of each of said security codes from said request to a respective one of said security codes in said further data segment.

28. An apparatus according to claim 25,
wherein said security code included in said request by said further section is a substantially random number selected dynamically by said further section; and
wherein said further security code added to said request by said additional section is a substantially random number selected dynamically by said additional section.

29. A method, comprising the steps of:
associating a unique identifier with a cartridge having an information storage media therein;
providing a receiving section into which said cartridge can be removably inserted, said receiving section being operatively coupled to a further section;
responding to the occurrence of a predetermined event when said cartridge is removably inserted in said receiving section by causing said receiving section to transmit to said further section public key information and an encrypted segment, where said encrypted segment has been formed through asymmetric encryption with a private key of a data segment which includes said unique identifier; and
decrypting said encrypted segment in said further section as a function of said public key information, in order to obtain access to said unique identifier.

30. A method according to claim 29,
including the step of maintaining in said further section a public key list containing a plurality of public keys, said public key information identifying one of said public keys in said list; and
wherein said decrypting step includes the step of using said one public key to effect said decryption of said encrypted segment.

31. A method according to claim 29, including the step of:
storing said private key, said public key information and said unique identifier in said cartridge during manufacture thereof; and
causing said receiving section to read said private key, said public key information and said unique identifier from said cartridge, and effect said asymmetric encryption of said unique identifier using said private key.

32. A method according to claim 31,
including the step of providing in said cartridge a secure memory device;
wherein said storing step is carried our by storing said private key, said public key information and said unique identifier in said secure memory device; and
including the step of causing said receiving section to authenticate with said secure memory device in order to obtain access to the information stored therein.

33. A method according to claim 32, including the steps of:
storing said unique identifier on said storage media during manufacture of said cartridge; and
causing said receiving section to compare said unique identifier stored on said storage media to said unique identifier stored in said secure memory device.

34. A method according to claim 31, including the step of maintaining a private key list in a secure manner at a facility associated with cartridge manufacture, said private key list including a plurality of private keys and corresponding public key identifiers, said private key used for asymmetric encryption being one of said private keys selected from said private key list, and said public key information being the public key identifier corresponding to said selected private key.

35. A method according to claim 34, including the steps of:
maintaining in said further section a public key list containing a plurality of public keys, said public key information identifying one of said public keys in said public key list; and
causing said further section to use said one public key to effect said decryption of said encrypted segment.

36. A method according to claim 31, including the step of causing said further section to transmit to said receiving section a request for said unique identifier, receipt of said request being said predetermined event.

37. A method according to claim 36, including the steps of:
causing said further section to place in said request a security code;
causing said receiving section to include said security code in said data segment in said encrypted segment transmitted to said further section in response to said request; and
causing said further section to effect a comparison of said security code sent in said request to said security code received in said data segment.

38. A method according to claim 37 including the steps of:
causing said further section and said receiving section to communicate with each other through an additional section;
causing said additional section to add to said request a further security code;
causing said receiving section to include said further security code in said data segment in said encrypted segment;
causing said additional section to decrypt said encrypted segment as a function of said public key information; and
causing said additional section to effect a comparison of said further security code sent in said request to said further security code received in said data segment.

39. A method according to claim 38, including the steps of:
maintaining in each of said further section and said additional section a public key list containing a plurality of public keys, said public key information identifying one of said public keys in said public key list; and
causing each of said further section and said additional section to use said one public key to effect said decryption of said encrypted segment.

40. A method according to claim 38, wherein said comparison step effected by said additional section includes the step of comparing each of said security codes from said request to a respective one of said security codes in said data segment.

41. A method according to claim 38, including the steps of:
causing said further section to dynamically select a substantially random number for use as said security code included in said request by said further section; and
causing said additional section to dynamically select a substantially random number for use as said further security code added to said request by said additional section.

42. A method according to claim 29, including the step of storing said encrypted segment and said public key information in said cartridge during manufacture thereof, said cartridge being free of said private key.

43. A method according to claim 42, including the steps of:
providing a secure memory device in said cartridge;
carrying out said storing step by storing said public key information and said encrypted segment in said secure memory device; and
causing said receiving section to authenticate with said secure memory device in order to obtain access to the information stored therein.

44. A method according to claim 42, including the step of maintaining a private key list in a secure manner at a facility associated with cartridge manufacture, said private key list including a plurality of private keys and corresponding public key identifiers, said private key used for asymmetric encryption being a selected one of said private keys from said private key list and said public key information being the public key identifier corresponding to said selected private key.

45. A method according to claim 44, including the steps of:
maintaining in said further section a public key list containing a plurality of public keys, said public key information identifying one of said public keys in said list; and
causing said further section to use said one public key to effect said decryption of said encrypted segment.

46. A method according to claim 42, including the steps of:
storing said unique identifier, a further private key, and further public key information in said cartridge during manufacture thereof;
causing said receiving section to read said further private key, said further public key information and said unique identifier from said cartridge;
causing said receiving section to form a further data segment which includes said encrypted segment, said public key information associated with said encrypted segment, and said unique identifier;
causing said receiving section to respond to said predetermined event by effecting asymmetric encryption of said further data segment using said further private key to obtain a further encrypted segment;
causing said receiving section to transmit said further encrypted segment and said further public key information to said further section; and
decrypting said further encrypted segment in said further section as a function of said further public key information.

47. A method according to claim 46, including the step of comparing in said receiving section said unique identifier from said further data segment with said unique identifier obtained by decrypting said encrypted segment in said further data segment.

48. A method according to claim 46, including the steps of:
providing in said cartridge includes a secure memory device;
carrying out said storing steps by storing said encrypted segment, said public key information associated with said encrypted segment, said unique identifier, said further private key, and said further public key information in said secure memory device; and
causing said receiving section to authenticate with said secure memory device in order to obtain access to the information stored therein.

49. A method according to claim 46, including the steps of:
maintaining first and second private key lists in a secure manner at a facility associated with cartridge manufacture, said first private key list including a plurality of first private keys and corresponding first public key identifiers, and said second private key list including a plurality of second private keys and corresponding second public key identifiers;
selecting one of said first private keys from said first private key list to be said private key used for asymmetric encryption of said encrypted segment stored in said cartridge, said corresponding public key information being the first public key identifier which corresponds to said selected first private key; and
selecting one of said second private keys from said second private key list to be said private key used for asymmetric encryption of said further encrypted segment, said further public key information being the second public key identifier which corresponds to said selected second private key.

50. A method according to claim 49, including the steps of:
maintaining in said further section first and second public key lists which respectively contain a plurality of first and second public keys, said public key information associated with said encrypted segment stored in said cartridge identifying one of said public keys in said first public key list, and said further public key information identifying one of said public keys in said second public key list; and
causing said further section to use said one of said second public keys to decrypt said further encrypted segment and to thereafter use said one of said first public keys to decrypt said encrypted segment from said further data segment.

51. A method according to claim 46, including the step of transmitting from said further section to said receiving section a request for said unique identifier, receipt of said request being said predetermined event.

52. A method according to claim 51, including the steps of:
causing said further section to place in said request a security code;
causing said receiving section to include said security code in said further data segment in said further encrypted segment transmitted to said further section in response to said request; and
causing said further section to effect a comparison of said security code sent in said request to said security code received in said further data segment.

53. A method according to claim 52, including the steps of:
causing said further section and said receiving section to communicate with each other through an additional section;
causing said additional section to add to said request a further security code;
causing said receiving section to include said further security code in said further data segment in said further encrypted segment;
causing said additional section to decrypt said further encrypted segment as a function of said further public key information; and
causing said additional section to effect a comparison of said further security code sent in said request to said further security code received in said further data segment.

54. A method according to claim 53, including the steps of:
maintaining in said further section first and second public key lists which respectively contain a plurality of first and second public keys, said public key information associated with said encrypted segment stored in said cartridge identifying one of said public keys in said first public key list, and said further public key information identifying one of said public keys in said second public key list;
maintaining in said additional section a duplicate of said second public key list;
causing said further section and said additional section to each use said one of said second public keys to decrypt said further encrypted segment; and
causing said further section to use said one of said first public keys to decrypt said encrypted segment from said further data segment.

55. A method according to claim 53, including the step of carrying out said comparison effected by said additional section so as to include the step of comparing each of said security codes from said request to a respective one of said security codes in said further data segment.

56. A method according to claim 53, including the steps of:
causing said further section to dynamically select a substantially random number for use as said security code included in said request by said further section; and
causing said additional section to dynamically select a substantially random number for use as said further security code added to said request by said additional section.
